(19) United States
(12) Patent Application Publication
(10) Pub. No.: US 2026/0044749 A1
(43) Pub. Date: Feb. 12, 2026

(54) SYSTEMS AND METHODS FOR GENERATING NATURAL SOLUTIONS TO A DESIGN TASK BY A LEARNING MODEL

(71) Applicant: Toyota Research Institute, Inc., Los Altos, CA (US)

(72) Inventors: Hyeonsu B. Kang, Pittsburgh, PA (US); Chuan-En Lin, Pittsburgh, PA (US); Nikolas A. Martelaro, Pittsburgh, PA (US); Aniket D. Kittur, Pittsburgh, PA (US); Yin-Ying Chen, San Jose, CA (US); Matthew K. Hong, Mountain View, CA (US)

(73) Assignees: Toyota Research Institute, Inc., Los Altos, CA (US); Toyota Jidosha kabushiki Kaisha, Toyota-shi Aichi-ken (JP); Carnegie Mellon University, Pittsburgh, PA (US)

(21) Appl. No.: 18/797,861

(22) Filed: Aug. 8, 2024

(51) Int. Cl. G06N 5/01

(52) U.S. Cl. CPC G06N 5/01

(57) ABSTRACT

Systems, methods, and other embodiments described herein relate to identifying and generating mechanisms from natural processes by a learning model for accelerating design development. In one example, a method for identifying and generating mechanisms from natural processes by a learning model to accelerate design development is disclosed. In one embodiment, the method includes identifying mechanisms for a design task using a prompt transformer with seeds from biological processes, and the prompt transformer forms a taxonomy tree using the mechanisms. The method also includes generating functional solutions that expand sparse branches of the taxonomy tree for the mechanisms using the prompt transformer and clustering the mechanisms into clusters using active ingredients associated with the mechanisms.

### TECHNICAL FIELD

The subject matter described herein relates, in general, to assisting a design task by a learning model and, more particularly, to identifying and generating mechanisms from natural processes by the learning model for accelerating design development.

### BACKGROUND

The background description provided is to present the context of the disclosure generally. Work of the inventor, to the extent it may be described in this background section, and aspects of the description that may not otherwise qualify as prior art at the time of filing, are neither expressly nor impliedly admitted as prior art against the present technology.

Systems can train a learning model to perform tasks when training data is robust. For example, a large language model (LLM) is a learning model that a system trains to solve a problem associated with a task through text prompts. However, complex tasks and problems can demand data curated by experts, which may be prohibitively expensive and sparse. Furthermore, LLMs generating solutions at times lack diversity and creativity when relating a problem associated with a task to uncommon solutions.

In various implementations, nature is an inspirational source for solutions to design and development tasks that are complex. Systems exploring natural domains involve analogical computations that encompass discovering and recognizing structural similarities between source and target analogs. Still, natural-analogical inspirations for engineering and design domains encounter difficulties associated with limited data and manual tasks. Furthermore, an LLM generating analogies for bio-inspired designs can have limited diversity even when tuning and adapting parameters. Therefore, systems implementing a learning model that derives solutions for complex design tasks from natural mechanisms encounter difficulties associated with manual controls and data scarcity.

### SUMMARY

This section generally summarizes the disclosure and is not a comprehensive explanation of its full scope or all its features.

In one embodiment, a design system for identifying and generating mechanisms from natural processes by a learning model to accelerate design development is disclosed. The design system includes a memory storing instructions that, when executed by a processor, cause the processor to identify mechanisms for a design task using a prompt transformer with seeds from biological processes, and the prompt transformer forms a taxonomy tree using the mechanisms. The instructions also include instructions to generate functional solutions that expand sparse branches of the taxonomy tree for the mechanisms using the prompt transformer. The instructions also include instructions to cluster the mechanisms into clusters using active ingredients associated with the mechanisms.

In another embodiment, a non-transitory computer-readable medium for identifying and generating mechanisms from natural processes by a learning model to accelerate design development and including instructions that, when executed by a processor, cause the processor to perform one or more functions is disclosed. The instructions include instructions to identify mechanisms for a design task using a prompt transformer with seeds from biological processes, and the prompt transformer forms a taxonomy tree using the mechanisms. The instructions also include instructions to generate functional solutions that expand sparse branches of the taxonomy tree for the mechanisms using the prompt transformer. The instructions also include instructions to cluster the mechanisms into clusters using active ingredients associated with the mechanisms.

In yet another embodiment, a method for identifying and generating mechanisms from natural processes by a learning model to accelerate design development is disclosed. In one embodiment, the method includes identifying mechanisms for a design task using a prompt transformer with seeds from biological processes, and the prompt transformer forms a taxonomy tree using the mechanisms. The method also includes generating functional solutions that expand sparse branches of the taxonomy tree for the mechanisms using the prompt transformer. The method also includes clustering the mechanisms into clusters using active ingredients associated with the mechanisms.

Further areas of applicability and various methods of enhancing the disclosed technology will become apparent from the description provided. The description and specific examples in this summary are intended for illustration only and are not intended to limit the scope of the present disclosure.

### BRIEF DESCRIPTION OF THE DRAWINGS

The accompanying drawings, which are incorporated in and constitute a part of the specification, illustrate various systems, methods, and other embodiments of the disclosure. It will be appreciated that the illustrated element boundaries (e.g., boxes, groups of boxes, or other shapes) in the figures represent one embodiment of the boundaries. In some embodiments, one element may be designed as multiple elements, or multiple elements may be designed as one element. In some embodiments, an element shown as an internal component of another element may be implemented as an external component and vice versa. Furthermore, elements may not be drawn to scale.

FIG. 1 illustrates one embodiment of a design system within which systems and methods disclosed herein may be implemented.

FIG. 2 illustrates embodiments of the design system that are associated with identifying mechanisms for a design task from nature and expanding a taxonomy tree including the mechanisms.

FIGS. 3A-3C illustrate embodiments of the design system generating an interface for interactively recognizing relevant mechanisms and adapting analogic mechanisms for the design task.

FIG. 4 illustrates one embodiment of a method that is associated with identifying mechanisms for a design task within a taxonomical framework and generating mechanisms that can be functional solutions that expand sparse branches using a prompt transformer.

### DETAILED DESCRIPTION

Systems, methods, and other embodiments associated with identifying and generating mechanisms from natural processes by a learning model for accelerating design development are disclosed herein. In various implementations, systems assisting design tasks by suggesting solutions to a design problem encounter difficulties with diversity and creativity. For example, prompting a large language model (LLM) to generate a design for a vehicle hood having reduced air resistance outputs limited solutions with expertly curated data that is scarce. In another example, systems explore natural domains for analogical processing that encompasses locating structural similarities between domains. Here, an analog may be an engineering and natural mechanism having a similar purpose (i.e., “solving what problem”) with diverse mechanisms (i.e., “how to solve the problem”), thereby leading to creative solutions. Still, natural-analogical inspirations for engineering and design domains can be biased toward organisms that are well-known and common. These systems can also demand humans intensively sifting through sources that are vast and fragmented (e.g., Wikipedia). Databases curated by human experts for streamlining searches can be costly to assemble and exhibit data scarcity, thereby limiting mechanisms available for making analogies. Furthermore, the automatic generation of analogies with an LLM that creates datasets for bio-inspired designs has limited diversity about abstract concepts even when tuning parameters, such as through logic suppression. As such, a learning model exploring analogs can be limited by existing designs and scarce data, thereby hindering creativity.

Therefore, in one embodiment, a design system identifies a mechanism dataset with a prompt transformer for a design task using seeds acquired from a source having natural processes (e.g., AskNature, DANE, SAPPHIRE, BioTRIZ, etc.). The design system generates mechanisms that expand sparse branches of a taxonomy tree formed with the mechanism dataset. Here, a prompt transformer may iteratively construct taxonomic hierarchies of organisms and diversify using knowledge prompts that are breadth-focused and depth-focused. For example, the prompt transformer computationally traverses the taxonomy tree to add a new entity of a taxonomic rank (e.g., a new genus) and augment an existing rank (e.g., existing genera) at sparse branches for the design problem. Furthermore, the design system organizes the mechanisms through clustering using active ingredients associated with the mechanisms. Using these clusters, the design system can then render an interface that displays the mechanisms as cluster cards.

Moreover, the rendered interface that displays the cluster cards can include other elements to assist with the design process. For example, the cluster cards may include a spark icon that generates new sparks of inspiration that build on a selected mechanism in a diversified for many previously generated sparks. Additionally, the cluster cards can also include a trade-off icon that generates a rundown of potential design trade-offs using the selected mechanism in the context of the design problem. Going even further, the cluster cards can also include an Ask AI icon that opens up a pop-up window with the text area for typing any requests, such as follow-up questions about the mechanism.

It will be appreciated that for simplicity and clarity of illustration, where appropriate, reference numerals have been repeated among the different figures to indicate corresponding or analogous elements. In addition, the discussion outlines numerous specific details to provide a thorough understanding of the embodiments described herein. Those of skill in the art, however, will understand that the embodiments described herein may be practiced using various combinations of these elements.

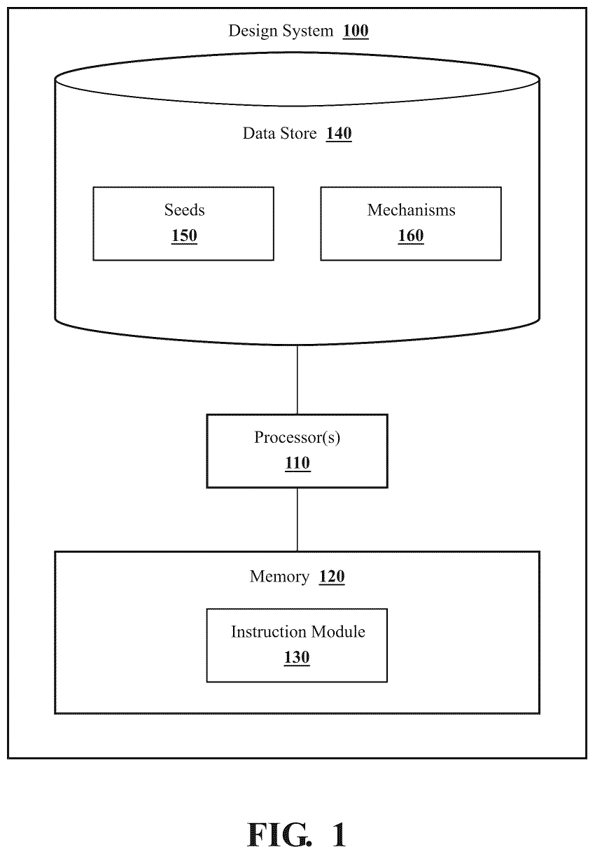

Referring to FIG. 1, one embodiment of the design system 100 is illustrated. The design system 100 is shown as including a processor(s) 110. The design system 100 may access the processor(s) 110 through a data bus or another communication path. In one embodiment, the design system 100 includes a memory 120 that stores an instruction module 130. The memory 120 is a random-access memory (RAM), a read-only memory (ROM), a hard disk drive, a flash memory, or other suitable memory for storing the instruction module 130. The instruction module 130 is, for example, computer-readable instructions that, when executed by the processor(s) 110, cause the processor(s) 110 to perform the various functions disclosed herein.

In various implementations, the design system 100 includes a data store 140. In one embodiment, the data store 140 is a database. The database is, in one embodiment, an electronic data structure stored in the memory 120 or another data store and that is configured with routines that can be executed by the processor(s) 110 for analyzing stored data, providing stored data, organizing stored data, and so on. Thus, in one embodiment, the data store 140 stores data used by the instruction module 130 in executing various functions. In one embodiment, the data store 140 includes the seeds 150 and the mechanisms 160. In one approach, the seeds 150 are data pairs having organisms and mechanisms with functional and aesthetic characteristics that are analogical to a design task. The design system 100 can acquire the seeds 150 for a design task from sources of expertly curated data that has quality and diversity, such as sources AskNature, DANE, SAPPHIRE, BioTRIZ, etc. As explained in detail below, the mechanisms 160 may be biological functions of organisms that may have analogies with a design task.

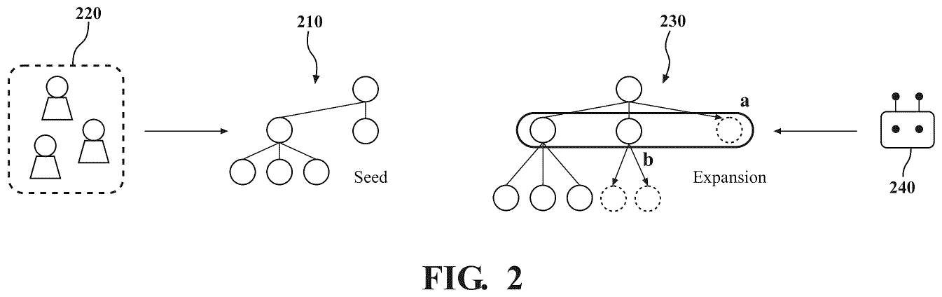

FIG. 2 illustrates embodiments of the design system 100 that is associated with identifying mechanisms for a design task from nature and expanding a taxonomy tree having the mechanisms. The instruction module 130, in one embodiment, includes instructions that cause the processor(s) 110 to generate and expand mechanisms from the seeds 210 identified by the design system 100. Initially, the design system 100 may identify mechanisms for a design task using a prompt transformer with the seeds 210 from biological processes, and the prompt transformer forms the taxonomy tree 230 from the mechanisms. Although certain examples herein implement a prompt transformer, the design system 100 may implement any LLM for identifying and generating mechanisms from natural processes associated with a design task. For example, the design system 100 instructs the prompt transformer (e.g., generative pre-trained transformer 4 (GPT-4)) to structure data from human experts 220 (e.g., AskNature posts, AskNature images, etc.) that is raw into problem-mechanism schemas.

Here, the data can be a curated list of organisms with detailed descriptions facilitating unique strategies for functional problems (e.g., manage impact, modify speed, etc.). The organisms and strategies can be grouped by function and viewed as a list. To curate the seeds 210 towards quality mechanisms, the design system 100 may predict a functional problem p that is relevant to a domain (e.g., automobile designers) and exclude irrelevant functions such as adapt behaviors, adapt genotype, co-evolve, maintain community, etc. The design system 100 can search a sub-list of organisms o∈O and strategies to p from the human experts 220 through a group-by-function feature by parsing web code (e.g., hypertext markup language (HTML) code). The design system 100 accesses the data from the human experts 220 for an organism-strategy using parsed universal resource locators (URL) and parses the returned web page for acquiring the title, description, and references as unstructured text.

Additionally, the design system 100 organizes the unstructured text that is raw into a mechanism description using the prompt transformer 240 associated with the instruction module 130. Here, the prompt transformer 240 can select a functional problem from the biological processes associated with a design task, access a subset of organisms associated with the functional problem, and structure the subset by textually describing the mechanisms. For example, the prompt transformer 240 compactly describes an identified mechanism of a data pair (o, p) having raw text and missing information related to the design task. In another approach, the prompt transformer 240 outputs a description of the mechanism when having complete information from the human experts 220 with input (o, p, Experts(o, p)). Regarding scenarios involving incomplete information, the mechanism description m outputted along with the function description may be a problem-mechanism schema for an organism: {o∈O|(p, m, o)}.

Moreover, the design system 100 traverses the taxonomy trece 230 using the prompt transformer 240 to add a new entity of a taxonomic rank (e.g., a new genus) a and augment an existing rank (e.g., existing genera) b at the sparse branches for the design task, such as with the seeds 210. For example, the design system 100 iteratively invokes the prompt transformer 240 to identify and generate relevant mechanisms for an inputted mechanism and problem using the problem-mechanism schemas as seeds. Here, the taxonomy tree 230 can expand by mixing breadth-focused and depth-focused strategies. At an iteration, the design system 100 constructs the taxonomy tree 230 using organisms represented in the generated mechanisms up to that point. The prompt transformer 240 extracts sibling taxonomies at a tree node for breadth-focused expansion with the new entity of the taxonomic rank (e.g., a new genus) a. Depth-focused expansion of children taxonomies is executed on the existing taxonomic rank b.

In one approach, an expansion strategy includes appending extracted taxonomies to a prompt as constraints (e.g., “come up with a few biological classes not in { . . . names of excluded classes . . . }”). For example, the breadth-focused expansion includes the system specifying the taxonomic level of generation (e.g., “biological classes”) and appending extracted taxonomies to a prompt as exclusion constraints. For depth-focused expansion, the system further specifies a parent taxon for generation in the prompt (e.g., “come up with a few biological families in the order araneae”) that can include exclusion constraints added to the prompt, thereby preventing generating already extracted taxons.

An expansion may continue and follow multiple levels of a natural hierarchy: {domain, kingdom, phylum, class, order, family, genus, species} where a domain represents the highest level and a species represents the lowest level on the hierarchy. The design system 100 focuses on species subparts for a relevant mechanism (e.g., adhesive paws of geckos, hierarchical layers in pomelo peels, etc.). Furthermore, the design system 100 can cut the taxonomy tree 230 at a level (e.g., class) for expansion and sort taxonomies (e.g., nodes) on the level by children nodes that are immediately in increasing order. Alternatively, the complete subtree is sorted rather than immediate children when computational resources are available.

For computational efficiency, the design system 100 may batch prompts for expansion by the prompt transformer 240. In one approach, the prompt transformer 240 increases the mechanisms within a section of the taxonomy tree 230 for a non-existing taxonomic rank using a first prompt(s). Next, the prompt transformer 240 expands outside the section of the taxonomy tree 230 for an existing taxonomic rank using a second prompt(s). This expansion includes adding mechanisms proximate to the existing taxonomic rank. For example, the prompt transformer 240 first expands selected prompts with breadth-focused expansion focused at a taxon level and existing nodes up to a predetermined amount (e.g., 50). Here, the prompt can ask, “come up with a few biological classes not in { . . . names of excluded classes . . . }.” The breadth-focused expansion instructs the prompt transformer 240 to repeat the following: 1) select a taxon from a list identified; and 2) compactly describe (e.g., 14 words or less) new mechanisms m associated with a problem p.

For the non-selected prompts, the prompt transformer 240 can expand existing children nodes randomly sampled and a new child node at a taxon level using the depth-focused expansion. For example, the prompt asks, “explore a few biological families in order arancae that are not any of {arancidae, . . . }.” In one approach, the depth-first expansion is followed by a breadth-focused expansion as further development. In this way, the design system 100 generates mechanisms efficiently from natural processes that expand solutions and the mechanisms within the taxonomy tree 230 through prompt batching that is strategic.

In various implementations, the design system 100 intelligently processes an existing dataset {∀ᵢ|(pᵢ, mᵢ, oᵢ)} and identifies similar mechanisms mᵢ in (pᵢ, mᵢ, oᵢ) and mⱼ in (pⱼ, mⱼ, oⱼ). These mechanisms can be mapped to disparate problems: mᵢ˜mⱼ→pᵢ, pⱼ. Upon formulating the enriched dataset {∀ᵢ|mᵢ→S(mᵢ)}, the design system 100 expands queries for problem text by constructing a similarity search index with text embedding. Here, S(mᵢ) denotes a set of design tasks applicable to mᵢ. In this way, the design system 100 improves solution robustness for a design task by searching for analogous mechanisms in unexplored areas.

Once generated, the mechanisms may be clustered based on the active ingredients of the different mechanisms. Moreover, this essentially enhances the design system's data focus around active ingredients, or transferable concepts in mechanism descriptions, to streamline downstream user interaction along the active ingredients. To this end, the design system 100 uses a backend dataset pipeline to process the mechanisms in the dataset to extract active ingredients and organize them in semantically meaningful clusters.

To extract active ingredient descriptions from mechanisms, the design system 100 uses a designed prompt for the prompt transformer 240 that includes a system message and a user message. Using the system message, design system 100 instructs the prompt transformer 240 with three criteria for identifying active ingredients. In one example, active ingredients that are short (i.e., 15 words or less) may be easier for a user to understand and increase the cluster separation by excluding secondary features of commonality among the species. Additionally, active ingredient descriptions with a verb or verb phrase may be easier to parse, as it often presents the information in the form of ‘what acts upon what.’

In order to organize the active ingredients in semantically meaningful groups, the design system 100 uses a recursive clustering algorithm. In one example, the recursive clustering algorithm iteratively targets the “could not cluster” cluster, which conventionally is denoted as the “−1” cluster in many off-the-shelf clustering algorithm outputs, including DBSCAN, to re-cluster among its members. To this end, the algorithm successively re-clusters using members of the −1 cluster generated from the previous run of clustering, with a gradual relaxation of the minimum distance parameter (denoted as e in DBSCAN) that decides the global sensitivity to cluster separation. The design system 100 may set this parameter to start at 0.3 and gradually increase with a decreasing slope, meaning the step increase added to the parameter at each run decreases over time, i.e., by a factor of 1.1, until no improvement in clustering results could be made even after the epsilon has increased.

Intuitively, this works by taking out the relatively straightforward clusters (i.e., groups of mechanisms with very similar surface text forms, resulting in very low distances among them in the embedding space) early on and by sufficiently lowering the sensitivity threshold subsequently in order to identify less obvious yet coherent clusters (i.e., groups of mechanisms that look different in the surface text form yet are semantically related, resulting in relatively higher distances among them) in the distance terrain of the remaining mechanisms. After the final run of the algorithm, if there remain any −1 cluster mechanisms, they are broken down into a series of singleton clusters, and appended to the end of the list to orient users towards clusters of multiple members for high information density clusters.

In order to visually represent the mechanisms, the design system 100 utilizes retrieval and/or generation-based approaches. In one example, the design system utilizes a retrieval-based approach to visually represent the mechanism and specifically to focus on finding effective animal portrait images. For example, the design system may use Google Search and Adobe Stock Images for this purpose. After that, in one example, using up to ten image candidates for each species, the design system 100 can rank them utilizing a transformer, such as GPT-4V by prompting the model with instructions for focusing on specific types of photos (i.e., “focus on one individual species, preferably in the wild, over cartoons, drawings, or the species photographed in the distance”) with potential value for mechanism understanding (i.e., “contains visual details that help viewers understand the following biological mechanisms . . . ”) In addition, the design system 100 may instruct the model to score all 10 candidate images from 0 to 100 in terms of goodness based on the criteria described above, and provide rationale for each.

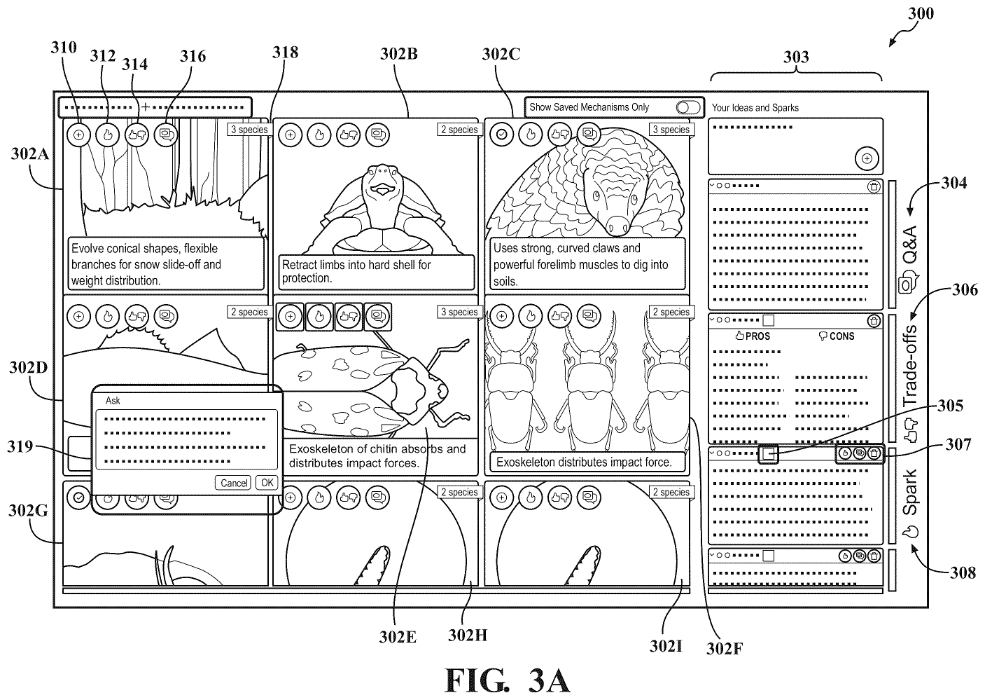

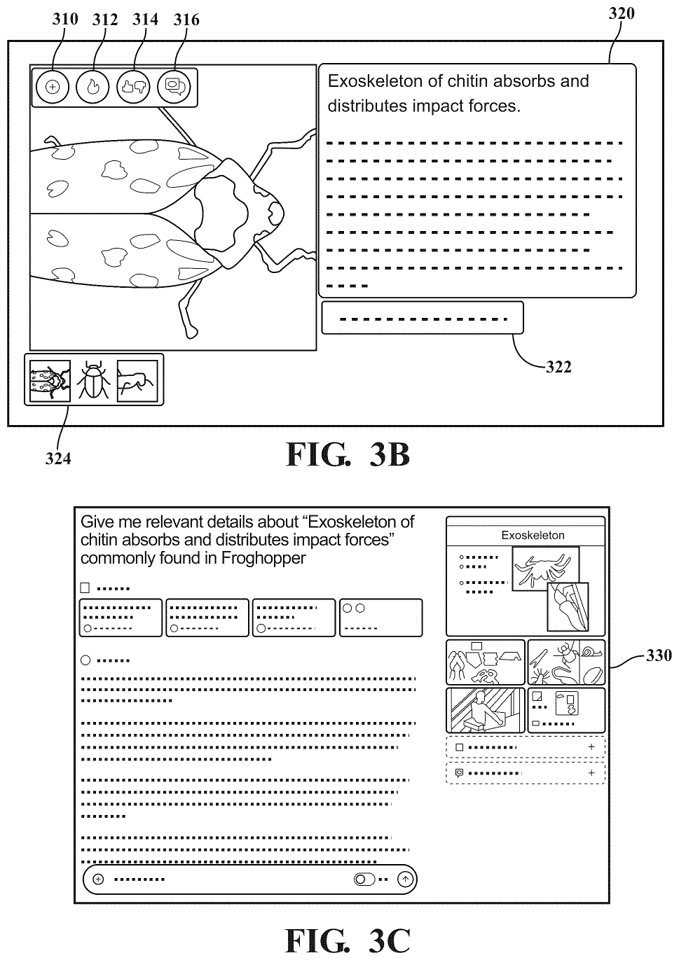

Now turning to FIGS. 3A-3C, the design system 100 generates an interface 300 for interactively recognizing relevant mechanisms and adapting analogic mechanisms for the design task are illustrated. Moreover, as best illustrated in FIG. 3A, mechanisms that have been clustered together in the previously described clustering operation are rendered as a cluster card 302A-302I. More simply, each of the cluster cards 302A-302I was rendered based on the clustering of similar mechanisms. As such, one cluster of similar mechanisms may be associated with the cluster card 302A, while another cluster of different mechanisms may be associated with the cluster card 302B.

Each of the cluster cards 302A-302I may include an image of the first (or user-selected in the cluster modal view) species in the cluster, its active ingredient description, action buttons 310-316, and a ribbon 318 indicating the size of the cluster. When one of the cluster cards 302A-302I is clicked, a modal view shows up, which is shown in FIG. 3B, revealing more details about each mechanism in the cluster.

The action buttons 310-316 include a save mechanism icon 310 which updates the count in the badge for the saved mechanisms, a spark icon 312 that generates new sparks of inspiration that build on the clicked mechanism and are diversified by previously generated sparks, a trade-off icon 314 that generates a rundown of potential design trade-offs of using the clicked mechanism in the context of the design problem, and an Ask AI icon 316 that opens up a pop-up window 319 with a text area for typing any requests (e.g., follow-up questions about the mechanism).

The interface 300 also includes a stream panel 303 that includes system and user-generated outputs, such as sparks 308, trade-offs 306, and responses to user questions 304. Each spark 308 may also include helpful features such as a caret for expanding/collapsing the card, the timestamp of creation, a clickable thumbnail 305 showing the source mechanism, which expands the modal view upon clicking it, and action buttons 307 for further generating new sparks of the spark content, Q&A, and deletion. The content of each spark may be directly editable.

As mentioned before, FIG. 3B illustrates a modal view of the clicked mechanism that shows additional mechanisms and active ingredient details in the display area 320. In addition, the modal view may utilize the same action buttons 310-316 as well as a see more details icon 322 that may link to a prompt transformer, which can provide additional details and related scientific research. A carousel display icon 324 may also be displayed that displays other species that belong to the cluster, which can be viewed by clicking any of the images forming the carousel display icon 324. FIG. 3C illustrates an example of results 330 from Perplexity.ai that opens up in a new browser tab when the user clicks on the see more details icon 322.

The sparks 308 may be generated utilizing a prompt transformer 240 each time the user clicks on the spark icon 312. The prompt essentially contextualizes the user-selected mechanism inspiration with the design problem description and the constraints provided with the problem. The design system 100 instructs the prompt transformer 240 to be succinct when generating sparks (i.e., under 500 characters) and provide a descriptive title for each. In addition, the prompt may also include a deliberate request that the new generation be novel and not redundant with any other previously generated sparks. The design system 100, in order to further facilitate users' engagement and exploration in a potentially interesting design space, may add two sparks whenever the user saves a mechanism inspiration as well.

The trade-offs 306 may be generated by the design system 100 using the prompt transformer 240 each time the user clicks on the trade-off icon 314. The prompt to generate the trade-offs 306 contextualizes the user-selected mechanism inspiration using the design problem description and the constraints provided with the problem. Moreover, the prompt instructs the prompt transformer to return the ‘pros’ and ‘cons’ of the mechanism inspiration in the context of the design problem using a markdown table format that places each pro-and-con pair in a new row and gives each item in the table a succinct (three words or less) label. In the view, the design system 100 displays the analysis in each trade-off 306 in the stream panel 303 and implements a scrollable and formatted table.

In order to flexibly respond to various requests that users could type in the question-and-answer text area (i.e., pop-up window 319) and generate appropriate responses, the design system 100 may utilize a two-stage process for handling user questions and answers. In the first action-triage stage, the design system prompts the prompt transformer 240 with user-typed text to act as an agent that reads the content and triages it to any of the following action choices with a text area for typing any requests (e.g., follow-up questions about the mechanism). These action choices may include (1) generate two related but highly different ideas based on the user-selected mechanism, (2) perform an analysis of anticipated pros-and-cons design trade-offs of applying the user-selected mechanism, (3) answer the user's follow-up question or respond to their comment related to the user-selected mechanism, or (4) none of the above actions are appropriate for the user comment, i.e., take no action. The design system 100 instructs the prompt transformer 240 to pick appropriate actions for each choice and return an appropriateness score and supporting rationale for the choice. The prompt system passes the latter information to the interface 300. In the second stage, a back end returns results to the interface 300.

In order to support user engagement with freshly produced sparks and other system-generated information, the design system 100 may organize the stream panel 303 by recency, placing the most recently generated items to the top. In addition, to support the efficient exploitation of an interesting design space, action buttons 307 are placed directly in each spark 308. The user can use these action buttons 307 to build off of any of the existing sparks in the stream, for example, by clicking on the spark generation or the Q&A button in the card. The design system 100 may leverage the same machinery for generating sparks as before but contextualize the generation using the selected spark in the stream panel 303 to anchor generation in the design space being exploited by the user. Furthermore, the stream panel 303 may contain helpful organizational features, such as quick filtering of different types of information (e.g., sparks, trade-offs, or Q&A, as well as deleted items with additional support for restoration.

As mentioned before, the interface 300 includes a see more details icon 322. The functionality of the see more details icon 322 includes opening up a browser tab that contains search results of relevant research from a website, such as Perplexity.ai. The query provided to the website could include something such as “give me relevant details about [active ingredient] commonly found in [species]. As mentioned before, an example of the output is shown in FIG. 3C.

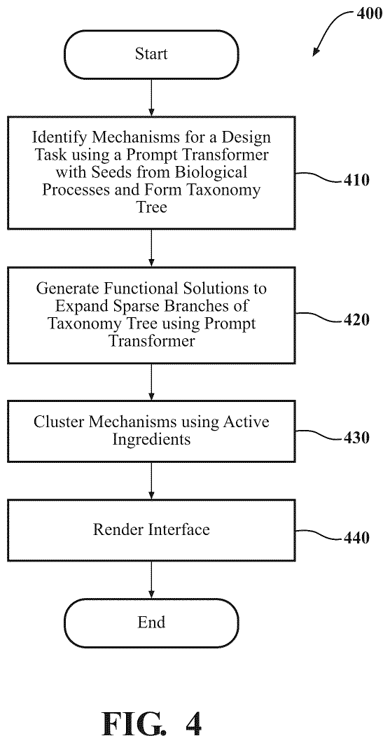

Now turning to FIG. 4, a flowchart of a method 400 that is associated with identifying mechanisms for a design task within a taxonomical framework and generating mechanisms that can be functional solutions that expand sparse branches using a prompt transformer is illustrated. Method 400 will be discussed from the perspective of the design system 100 of FIG. 1. While method 400 is discussed in combination with the design system 100, it should be appreciated that the method 400 is not limited to being implemented within the design system 100 but is instead one example of a system that may implement the method 400.

At step 410, the design system 100 identifies mechanisms for a design task using a prompt transformer (e.g., GPT-3.5, GPT-4, etc.) with seeds from biological processes and forms a taxonomy tree. Here, the design system 100 can identify mechanisms for the design task by invoking a prompt transformer with seeds representing biological processes. Initially, the prompt transformer forms the taxonomy tree from the mechanisms according to the seeds. For example, the prompt transformer acquires and structures data from human experts (e.g., AskNature information) that is raw into problem-mechanism schemas. This data can be curated information about organisms with detailed descriptions of unique strategies for functional problems (e.g., manage impact, modify speed, etc.). The design system 100 may predict a functional problem p that is relevant to a design domain and curate the seeds with quality mechanisms.

As previously explained, in one approach, the design system 100 searches the sub-list of organisms o∈O and strategies to p from human experts by parsing web code and accessing data for an organism-strategy. Furthermore, the design system 100 organizes the unstructured and raw text into a mechanism description using the prompt transformer. For example, the prompt transformer selects a functional problem from the biological processes associated with the design task, accesses a subset of organisms associated with the functional problem, and structures the subset by textually describing the mechanisms. Additionally, the prompt transformer can compactly describe an identified mechanism of a data pair (o, p) having raw text and missing information related to the design task. In another approach, the prompt transformer outputs a mechanism description when having complete information from the human experts with input (o, p, Experts(o, p)). The mechanism description m outputted along with the function description may also be a problem-mechanism schema for an organism: {o∈O|(p, m, o)} when involving incomplete information.

At step 420, the instruction module 130 generates functional solutions to expand sparse branches of the taxonomy tree for the mechanisms using the prompt transformer. Here, the design system 100 can traverse the taxonomy tree for adding a new entity of a taxonomic rank and augmenting an existing taxonomic rank at the sparse branches for the design task. As previously explained, in one embodiment, the design system 100 iteratively invokes the prompt transformer to identify and generate relevant mechanisms for an inputted mechanism and problem using seeds from expertly curated data. The taxonomy tree can expand by mixing breadth-focused and depth-focused strategies. A breadth-focused expansion may comprise extracting sibling taxonomies with a new entity of a taxonomic rank for the design task. A depth-focused expansion may comprise adding child taxonomies to an existing taxonomic rank.

Moreover, extracted taxonomies for an expansion strategy may be appended to prompts as constraints. In one approach, the expansion strategy follows a hierarchy from nature: {domain, kingdom, phylum, class, order, family, genus, species}. Here, a domain represents the highest level, and a species represents the lowest level within the taxonomic tree. As a further optimization, the design system 100 can cut and trim the taxonomy tree at a level (e.g., class) for expansion and sort taxonomies on a level by children nodes following an increasing order.

At step 430, the design system 100 clusters mechanisms based on the active ingredients of the different mechanisms. To this end, the design system 100 uses a backend dataset pipeline to process the mechanisms in the dataset to extract active ingredients and organize them in semantically meaningful clusters. To extract active ingredient descriptions from mechanisms, the design system 100 uses a designed prompt for the prompt transformer 240 that includes a system message and a user message. Using the system message, design system 100 instructs the prompt transformer 240 with three criteria for identifying active ingredients. In order to organize the active ingredients in semantically meaningful groups, the design system 100 uses a recursive clustering algorithm.

At step 440, the design system 100 renders an interface, the design system 100 generates an interface 300 for interactively recognizing relevant mechanisms and adapting analogic mechanisms for the design task are illustrated. Moreover, as best illustrated in FIG. 3A, mechanisms that have been clustered together in the previously described clustering operation are rendered as a cluster card 302A-302I. More simply, each of the cluster cards 302A-302I was rendered based on the clustering of similar mechanisms. As such, one cluster of similar mechanisms may be associated with the cluster card 302A, while another cluster of different mechanisms may be associated with the cluster card 302B. Each of the cluster cards 302A-302I may include an image of the first (or user-selected in the cluster modal view) species in the cluster, its active ingredient description, action buttons 310-316, and a ribbon 318 indicating the size of the cluster. When one of the cluster cards 302A-302I is clicked, a modal view shows up, which is shown in FIG. 3B, revealing more details about each mechanism in the cluster.

Detailed embodiments are disclosed herein. However, it is to be understood that the disclosed embodiments are intended as examples. Therefore, specific structural and functional details disclosed herein are not to be interpreted as limiting but merely as a basis for the claims and as a representative basis for teaching one skilled in the art to variously employ the aspects herein in virtually any appropriately detailed structure. Furthermore, the terms and phrases used herein are not intended to be limiting but rather to provide an understandable description of possible implementations. Various embodiments are shown in FIGS. 1-4, but the embodiments are not limited to the illustrated structure or application.

The flowcharts and block diagrams in the figures illustrate the architecture, functionality, and operation of possible implementations of systems, methods, and computer program products according to various embodiments. In this regard, a block in the flowcharts or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved.

The systems, components, and/or processes described above can be realized in hardware or a combination of hardware and software and can be realized in a centralized fashion in one processing system or in a distributed fashion where different elements are spread across several interconnected processing systems. Any processing system or another apparatus adapted for carrying out the methods described herein is suited. A typical combination of hardware and software can be a processing system with computer-usable program code that, when being loaded and executed, controls the processing system such that it carries out the methods described herein.

The systems, components, and/or processes also can be embedded in a computer-readable storage, such as a computer program product or other data programs storage device, readable by a machine, tangibly embodying a program of instructions executable by the machine to perform methods and processes described herein. These elements also can be embedded in an application product, which comprises the features enabling the implementation of the methods described herein and which, when loaded in a processing system, is able to carry out these methods.

Furthermore, arrangements described herein may take the form of a computer program product embodied in one or more computer-readable media having computer-readable program code embodied, e.g., stored, thereon. Any combination of one or more computer-readable media may be utilized. The computer-readable medium may be a computer-readable signal medium or a computer-readable storage medium. The phrase “computer-readable storage medium” means a non-transitory storage medium. A computer-readable storage medium may be, for example, but not limited to, an electronic, magnetic, optical, electromagnetic, infrared, or semiconductor system, apparatus, or device, or any suitable combination of the preceding. More specific examples (a non-exhaustive list) of the computer-readable storage medium would include the following: a portable computer diskette, a hard disk drive (HDD), a solid-state drive (SSD), a ROM, an EPROM or flash memory, a portable compact disc read-only memory (CD-ROM), a digital versatile disc (DVD), an optical storage device, a magnetic storage device, or any suitable combination of the preceding. In the context of this document, a computer-readable storage medium may be any tangible medium that can contain or store a program for use by or in connection with an instruction execution system, apparatus, or device.

Generally, modules, as used herein, include routines, programs, objects, components, data structures, and so on that perform particular tasks or implement particular data types. In further aspects, a memory generally stores the noted modules. The memory associated with a module may be a buffer or cache embedded within a processor, a RAM, a ROM, a flash memory, or another suitable electronic storage medium. In still further aspects, a module as envisioned by the present disclosure is implemented as an ASIC, a hardware component of a system on a chip (SoC), as a programmable logic array (PLA), or as another suitable hardware component that is embedded with a defined configuration set (e.g., instructions) for performing the disclosed functions.

Program code embodied on a computer-readable medium may be transmitted using any appropriate medium, including but not limited to wireless, wireline, optical fiber, cable, radio frequency (RF), etc., or any suitable combination of the preceding. Computer program code for carrying out operations for aspects of the present arrangements may be written in any combination of one or more programming languages, including an object-oriented programming language such as Java™, Smalltalk™, C++, or the like and conventional procedural programming languages, such as the “C” programming language or similar programming languages. The program code may execute entirely on the user's computer, partly on the user's computer, as a stand-alone software package, and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

The terms “a” and “an,” as used herein, are defined as one or more than one. The term “plurality,” as used herein, is defined as two or more than two. The term “another,” as used herein, is defined as at least a second or more. The terms “including” and/or “having,” as used herein, are defined as comprising (i.e., open language). The phrase “at least one of . . . and . . . ” as used herein refers to and encompasses any and all combinations of one or more of the associated listed items. As an example, the phrase “at least one of A, B, and C” includes A, B, C, or any combination thereof (e.g., AB, AC, BC, or ABC).

Aspects herein can be embodied in other forms without departing from the spirit or essential attributes thereof. Accordingly, reference should be made to the following claims rather than to the preceding specification, as indicating the scope hereof.

What is claimed is:

1. A system comprising a memory including instructions that, when executed by a processor, cause the processor to:
identify mechanisms for a design task using a prompt transformer with seeds from biological processes, the prompt transformer forms a taxonomy tree using the mechanisms;
generate functional solutions that expand sparse branches of the taxonomy tree for the mechanisms using the prompt transformer; and
cluster the mechanisms into clusters using active ingredients associated with the mechanisms.

2. The system of claim 1, wherein the instructions to generate the functional solutions include instructions that, when executed by the processor, cause the processor to traverse the taxonomy tree by the prompt transformer to add a new entity of a taxonomic rank and augment an existing taxonomic rank at the sparse branches for the design task according to the seeds.

3. The system of claim 2, wherein the instructions to traverse the taxonomy tree include instructions that, when executed by the processor, cause the processor to:
increase the mechanisms by the prompt transformer within a section of the taxonomy tree for the new entity of the taxonomic rank using a first prompt;
expand the mechanisms by the prompt transformer outside the section of the taxonomy tree for the existing taxonomic rank using a second prompt; and
structure the mechanisms by a learning model into a data pair of functions and organisms within the taxonomy tree.

4. The system of claim 1, wherein the instructions to identify the mechanisms include instructions that, when executed by the processor, cause the processor to:
select a functional problem by the prompt transformer from the biological processes associated with the design task;
access a subset of organisms associated with the functional problem; and
structuring the subset using the prompt transformer by textually describing the mechanisms.

5. The system of claim 4, wherein a problem schema includes the subset, the functional problem, and one of the mechanisms.

6. The system of claim 1, wherein the instructions to cluster the mechanisms include instructions that, when executed by the processor, cause the processor to:
extract the active ingredients of the mechanisms using the prompt transformer; and
recursively cluster the active ingredients of the mechanisms to generate the clusters.

7. The system of claim 1, further including instructions that, when executed by the processor, causes the processor to render an interface that displays the mechanisms as cluster cards.

8. The system of claim 1, wherein the design task is an engineering problem and the seeds have functional characteristics and aesthetic characteristics that are analogical.

9. The system of claim 1, wherein the seeds are data pairs having organisms and the biological processes that are expertly curated, and the prompt transformer is a large language model (LLM) that interprets the data pairs.

10. A method comprising:
identifying mechanisms for a design task using a prompt transformer with seeds from biological processes, the prompt transformer forms a taxonomy tree using the mechanisms;
generating functional solutions that expand sparse branches of the taxonomy tree for the mechanisms using the prompt transformer; and
clustering the mechanisms into clusters using active ingredients associated with the mechanisms.

11. The method of claim 10, wherein generating the functional solutions further includes traversing the taxonomy tree by the prompt transformer to add a new entity of a taxonomic rank and augmenting an existing taxonomic rank at the sparse branches for the design task according to the seeds.

12. The method of claim 11, wherein traversing the taxonomy tree further includes:
increasing the mechanisms by the prompt transformer within a section of the taxonomy tree for the new entity in the taxonomic rank using a first prompt;
expanding the mechanisms by the prompt transformer outside the section of the taxonomy tree for the existing taxonomic rank using a second prompt; and
structuring the mechanisms by a learning model into a data pair of functions and organisms within the taxonomy tree.

13. The method of claim 10, wherein identifying the mechanisms further includes:
selecting a functional problem by the prompt transformer from the biological processes associated with the design task;
accessing a subset of organisms associated with the functional problem; and
structuring the subset using the prompt transformer by textually describing the mechanisms.

14. The method of claim 13, wherein a problem schema includes the subset, the functional problem, and one of the mechanisms.

15. The method of claim 10, wherein clustering the mechanisms further includes:
extracting the active ingredients of the mechanisms using the prompt transformer; and
recursively clustering the active ingredients of the mechanisms to generate the clusters.

16. The method of claim 10, further comprising rendering an interface that displays the mechanisms as cluster cards.

17. The method of claim 10, wherein the design task is an engineering problem and the seeds have functional characteristics and aesthetic characteristics that are analogical.

18. The method of claim 10, wherein the seeds are data pairs having organisms and the biological processes that are expertly curated, and the prompt transformer is a large language model (LLM) that interprets the data pairs.

19. A non-transitory computer-readable medium comprising instructions that, when executed by a processor, cause the processor to:
identify mechanisms for a design task using a prompt transformer with seeds from biological processes, the prompt transformer forms a taxonomy tree using the mechanisms;
generate functional solutions that expand sparse branches of the taxonomy tree for the mechanisms using the prompt transformer; and
cluster the mechanisms into clusters using active ingredients associated with the mechanisms.

20. The non-transitory computer-readable medium of claim 19, wherein the instructions to cluster the mechanisms include instructions that, when executed by the processor, cause the processor to:
extract the active ingredients of the mechanisms using the prompt transformer; and
recursively cluster the active ingredients of the mechanisms to generate the clusters.
